(19) United States
(12) Patent Application Publication
(10) Pub. No.: US 2026/0214319 A1
(43) Pub. Date: Jul. 23, 2026

(54) IMAGING APPARATUS AND CONTROL METHOD THEREOF

(71) Applicant: CANON KABUSHIKI KAISHA, Tokyo (JP)

(72) Inventors: YUI TADA, Tokyo (JP); TAKASHI GYOTOKU, Kanagawa (JP)

(21) Appl. No.: 19/383,401

(22) Filed: Nov. 7, 2025

(30) Foreign Application Priority Data
Nov. 20, 2024 (JP) 2024-202203

(51) Int. Cl. H04N 23/63; H04N 23/68; H04N 23/951

(52) U.S. Cl. CPC H04N 23/632; H04N 23/683; H04N 23/6845; H04N 23/951

(57) ABSTRACT

Control is performed to capture a plurality of frames of live view images before execution of continuous capturing of a plurality of frames of still images and to display the captured plurality of frames of live view images on a display unit in a predetermined cycle. And control is performed to continuously capture the plurality of frames of still images without capturing the plurality of frames of live view images during execution of the continuous capturing and to display at least some of the plurality of frames of still images as some of the plurality of frames of live view images on the display unit in the predetermined cycle.

### BACKGROUND

### Field of Technology

The present disclosure relates to an imaging apparatus and a control method thereof.

### Description of the Related Art

In recent years, there have been proposed imaging apparatuses, such as digital cameras, that can both continuously capture still images for recording and display live view images. Japanese Patent Laid-Open No. 2022-120682 describes a technique for reducing the exposure difference between live view images and still images for recording by combining a plurality of frames of images output from an imaging element.

However, according to Japanese Patent Laid-Open No. 2022-120682, in continuously capturing recording still images, there is an issue in that a display of live view image may cause a feeling of strangeness due to the timing for reading out live view images and still images for recording from the imaging element and the timing for displaying the live view images.

### SUMMARY

According to an aspect of the present disclosure, an imaging apparatus includes an imaging element, a display unit configured to display a live view image captured by the imaging element, at least one processor, and at least one memory that is in communication with the at least one processor. The at least one memory stores instructions for causing the at least one processor and the at least one memory to execute performing control to capture a plurality of frames of live view images by the imaging element before execution of continuous capturing of a plurality of frames of still images and to display the captured plurality of frames of live view images on the display unit in a predetermined cycle, and performing control to continuously capture the plurality of frames of still images by the imaging element without capturing the plurality of frames of live view images during execution of the continuous capturing and to display at least some of the plurality of frames of still images as some of the plurality of frames of live view images on the display unit in the predetermined cycle.

Features of various embodiments will become apparent from the following description of embodiments with reference to the attached drawings. The following description of embodiments is described by way of example.

### BRIEF DESCRIPTION OF THE DRAWINGS

FIG. 1 is a diagram illustrating an overall configuration of an imaging apparatus in an embodiment of the present disclosure.

FIG. 2 is a diagram illustrating a configuration of an imaging element and its surroundings in the embodiment of the present disclosure.

FIGS. 3A and 3B are diagrams illustrating an operation flow of reading out an image signal from the imaging element and displaying a live view in the embodiment of the present disclosure.

FIG. 4 is a diagram illustrating a configuration of an imaging element and its surroundings in an embodiment of the present disclosure.

FIG. 5 is a diagram illustrating an operation flow of reading out an image signal from the imaging element and displaying a live view in the embodiment of the present disclosure.

FIG. 6 is a flowchart illustrating a flow of changing a continuous imaging method in an embodiment of the present disclosure.

### DESCRIPTION OF THE EMBODIMENTS

Hereinafter, embodiments of the present disclosure will be described in detail with reference to the accompanying drawings.

### First Embodiment

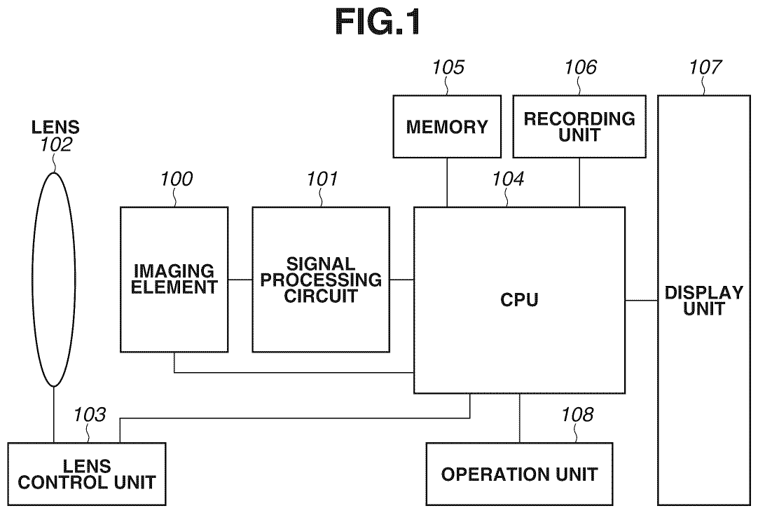

FIG. 1 is a diagram schematically illustrating an overall configuration of an imaging apparatus in a first embodiment of the present disclosure.

A lens 102 forms an incident optical image on an imaging element 100.

The imaging element 100 converts the optical image formed by the lens 102 into an image signal, and outputs the converted image signal to a signal processing circuit 101.

The signal processing circuit 101 performs predetermined processing on the image signal output from the imaging element 100 to generate captured image data and image data for focus detection.

A lens control unit 103 controls the zoom, focus, and aperture of the lens 102.

The CPU 104 performs various controls of the imaging element 100, the signal processing circuit 101, and the lens control unit 103.

A memory 105 is used to temporarily record image data processed by the signal processing circuit 101 and others.

A recording unit 106 records image data processed by the signal processing circuit 101 in a semiconductor memory (not illustrated) or reads out image data from the semiconductor memory.

A display unit 107 displays various types of information, such as captured live view images, images for recording, or exposure conditions.

An operation unit 108 includes operation buttons, dials, and others, and can be used to make various settings for the imaging apparatus. The operation unit 108 can also be used to instruct high-speed continuous capturing of still images for recording during display of a live view image.

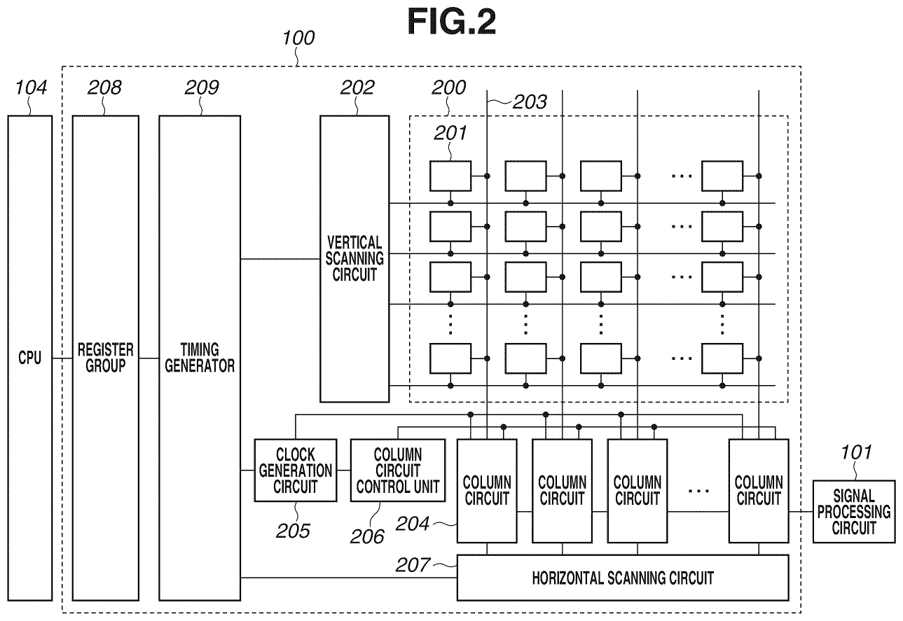

FIG. 2 is a diagram illustrating an overall configuration of the imaging element 100 in the first embodiment of the present disclosure.

A pixel group 200 has pixels 201 arranged in a matrix. Each pixel 201 has a photoelectric conversion unit, a transistor, and the like. Each pixel 201 may have a plurality of photoelectric conversion units. For example, focus detection of a subject can be performed by comparing output signals from the plurality of photoelectric conversion units and performing phase difference detection. A sum signal obtained by adding up the output signals from the plurality of photoelectric conversion units can be used to generate a captured image.

A vertical scanning circuit 202 supplies drive signals for controlling transistors (not illustrated) included in the pixels 201 to individual pixel rows of the pixel group 200. At least one column signal line 203 is provided for each pixel column of the pixel group 200, thereby the read output signals from the pixels 201 are transferred to a column circuit 204.

The column circuit 204 performs various processes such as analog/digital (A/D) conversion on the output signals from the pixels 201 having been transferred through the column signal line 203. A clock generation circuit 205 generates a control signal for the column circuit 204 based on a clock signal supplied from a timing generator 209, and supplies the control signal to a column circuit control unit 206.

The column circuit control unit 206 controls each column circuit 204 based on the control signal supplied from the clock generation circuit 205. A horizontal scanning circuit 207 transfers the output signals from the pixels 201 having been processed by the column circuits 204 to the signal processing circuit 101.

A register group 208 stores the settings of each operation mode transmitted from an external control device such as the CPU 104. The timing generator 209 operates the vertical scanning circuit 202, the clock generation circuit 205, and the horizontal scanning circuit 207, based on the settings stored in the register group 208.

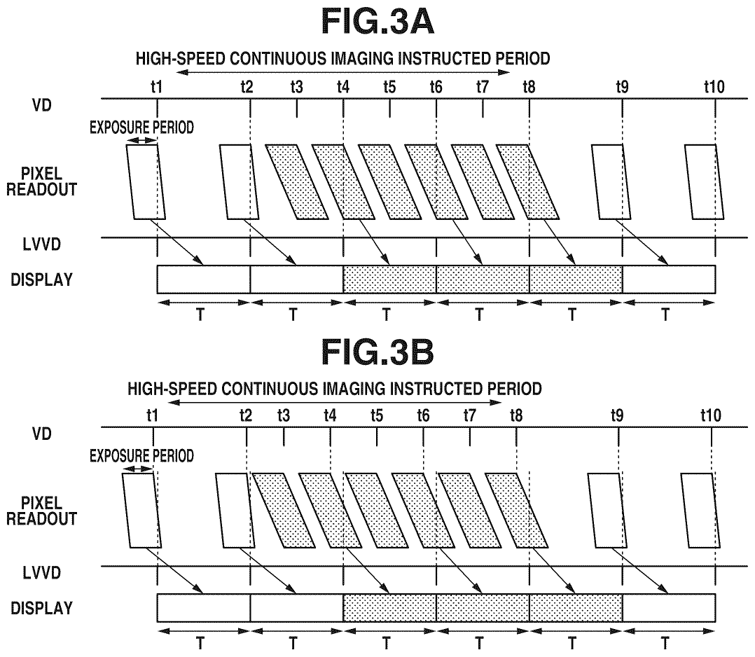

FIGS. 3A and 3B are diagrams illustrating an operational flow of reading out image signals from the imaging element 100 and displaying live view images on the display unit 107. Described here is a method for reading out image signals from the imaging element 100 in a case where high-speed continuous imaging is instructed and using still images continuously captured at high speed for live view display. The live view images are displayed on the display unit 107 in a preset display cycle T (predetermined cycle).

Image signals are read out from the pixel group 200 of the imaging element 100 for each vertical synchronization signal VD supplied from the CPU 104. The image signals read out from the imaging element 100 are subjected to predetermined processing, such as various correction processes and development processes in the signal processing circuit 101, and are displayed on the display unit 107 as live view images in synchronization with a display vertical synchronization signal LVVD supplied from the CPU 104.

FIG. 3A is a timing chart in which the timing for starting image signal readout from the imaging element 100 coincides with the timing for starting display on the display unit 107.

At time t1, high-speed continuous capturing of still images has not been instructed (before execution of high-speed continuous imaging), so that a normal live view image display operation is performed. A live view image based on a live view image signal read from the imaging element 100 is displayed on the display unit 107.

If high-speed continuous capturing of still images is instructed between time t1 and time t2, the CPU 104 transmits settings for a still image capturing operation to the imaging element 100.

At time t2, in the same way as at time t1, a normal live view display operation is performed, and a live view image based on a live view image signal read out from the imaging element 100 is displayed on the display unit 107. At this time, the period from time t1 to time t2 (live view VD period), which is the readout cycle of the live view image signal from the imaging element 100, coincides with the display cycle T (predetermined cycle). For this reason, the readout of the live view image signals and the display of the live view images on the display unit 107 are synchronized to achieve a display of natural live view images without a feeling of strangeness. That is, when a live view image signal is displayed on the display unit 107, a natural image display can be achieved, provided that Equation (1) below is satisfied:

$$LV operation readout cycle = displayed cycle T \qquad ( Equation 1 )$$

Next, the imaging apparatus operates for still image capturing to perform the instructed high-speed continuous capturing of still images. In order to perform high-speed continuous capturing of still images, still image signals for the first frame starts to be accumulated between time t2 and time t3. The still image signals having started to be read out at time t3 are corrected and developed by the signal processing circuit 101 and then recorded in the memory 105 or the recording unit 106. Because the period from time t2 to time t3 is shorter than the display cycle T (predetermined cycle), the display vertical synchronization signal LVVD is not supplied, and the still image signals read out from time t3 are not used for live view display.

At time t4, since the instruction for high-speed continuous capturing of still images continues (high-speed continuous capturing of still images is in progress), the operation for still image capturing is performed in the same manner as at time t3. In this case, the period from time t2 to time t4 coincides with the display cycle T (predetermined cycle), and at time t4, the vertical synchronization signal VD and the display vertical synchronization signal LVVD are supplied at the same timing. Accordingly, the still image signals read out from time t4 are displayed as live view images on the display unit 107, so that it is possible to achieve synchronization between the readout of still image signals and the display of live view images, thereby realizing a display of natural live view images without a feeling of strangeness. That is, at least some of the frames of the plurality of still images are displayed as live view images.

In this manner, as in the case of reading live view image signals, the still image signals are read out at the timing when the display vertical synchronization signal LVVD is supplied. Then, the readout still image signals are used for display so that it is possible to realize a natural display without a feeling of strangeness, with synchronization between the readout of the image signals and the display of the live view images.

The image signals used to display the live view images on the display unit 107 may not only be the still image signals read out from time t4, but may also be image signals obtained by adding up with still image signals for a plurality of frames read out at other times. In this case, even if the exposure period of the still image signals is different from the exposure period of the live view image signals, the exposure period of the still image signals can be matched with the exposure period of the live view image signals to make uniform the blur and brightness of the subject, thereby further reducing a feeling of strangeness in display.

Furthermore, the barycenter of exposure of the live view images may be adjusted by limiting or weighting the frames of the still image signals to be added. This makes more uniform the display of subject blur in the live view image generated from the live view image signal and the live view image generated from the still image signal.

At time t4, the live view image displayed on the display unit 107 is switched from an image based on the live view image signal to an image based on the still image signal. This achieves seamless switching of live view image display without causing a frame stop or blackout. In order to read out still image signals from the imaging element 100 at intervals of the live view image display cycle T (predetermined cycle) as described above, if the still image readout cycle is constant, it needs to be an integral multiple of the display cycle T (predetermined cycle), as in Equation (2) as follows:

$$Readout cycle of still image signals = N \times display cycle T ( N is any positive integer ) \qquad ( Equation 2 )$$

The readout cycle of still image signals (for example, the interval between time t3 and time t4) is the reciprocal of the frame rate of the set high-speed continuous imaging. In FIG. 3A, the readout cycle of still image signals is twice (N=2) the display cycle T (predetermined cycle) of live view images. Because two frames of still image signals can be read out in the display cycle of one frame of live view image, an image signal that is not used to display the live view image is read out once every two frames, such as the still image signal read out from time t3.

At time t5, the instruction for high-speed continuous imaging continues to be issued, so the readout operation of still image signals is performed. Because the period from time t4 to time t5 is shorter than the display cycle T (predetermined cycle) of live view images, the display vertical synchronization signal LVVD is not supplied during the period, and the still image signals read out from time t5 are not used to display the live view images.

From time t6 to time t8, in the same manner as from time t4 to time t6, the still image signals read out from time t6 are displayed as live view images at the timing when the display vertical synchronization signal LVVD and the vertical synchronization signal VD coincide. This makes it possible to realize a display of natural live view images in which the readout of the still image signals and the display of the live view images are synchronized, without a feeling of strangeness.

Subsequently, when the instruction for high-speed continuous imaging is canceled between time t7 and time t8, the CPU 104 transmits settings for a live view image capturing operation to the imaging element 100.

At time t8, still image signals are read out, and then live view image signals start to be accumulated between time t8 and time t9. The live view image signals that start to be read out at time t9 are subjected to correction processing and development processing in the signal processing circuit 101, and are displayed as live view images on the display unit 107 in synchronization with the display vertical synchronization signal LVVD.

After time t9, the readout of still image signals is not performed, and the readout of live view image signals and the display of live view images are repeated in the same manner as from time t1 to time t2. In this manner, at time t9, live view images displayed on the display unit 107 are switched again from the images based on the still image signals to the images based on the live view image signals. This makes it possible to realize seamless switching of the live view image display without causing a frame stop or blackout.

As described above with reference to FIG. 3A, the intervals of the display vertical synchronization signal LVVD and the vertical synchronization signal VD for reading the frames of image signals used for live view images are matched in the readout operation of live view image signals and the readout operation of still image signals. This realizes natural live view display without a feeling of strangeness.

However, in the control of FIG. 3A, if there is a large difference between the time required to read out one frame of live view image signal and the time required to read out one frame of still image signal, a situation as described below may occur. That is, there may occur a large difference between the timing for reading out the final pixel row of live view image signals and the timing for displaying live view images, and the timing for reading out the final pixel row of still image signals and the timing for displaying live view images.

Accordingly, if there is a large difference in the time required to read one frame of image signal between the readout operation of the live view image signal and the readout operation of the still image signal, control can be performed as illustrated in FIG. 3B. That is, the interval of the display vertical synchronization signal LVVD and the interval of the vertical synchronization signal VD are controlled separately in the case of displaying a live view image based on the live view image signal and in the case of displaying a live view image based on the still image signal.

Referring to FIG. 3B, as compared to the case in FIG. 3A, the barycenter of the readout time (median value of the readout time) of still image signals is controlled to coincide with the timing for starting display of live view images. This control can reduce the difference between the timing for reading out the final pixel row of live view image signals and the timing for displaying live view images, and the difference between the timing for reading out the final pixel row of still image signals and the timing for displaying live view images.

As described above, the interval of the display vertical synchronization signal LVVD and the interval of the vertical synchronization signal VD are controlled in the case of displaying a live view image based on a live view image signal and in the case of displaying a live view image based on a still image signal. This control realizes a display of natural live view images without a feeling of strangeness.

According to the present embodiment described above, in a case where continuous imaging is instructed and continuously captured still images are used to display live view images, it is possible to achieve a display of seamless, natural live view images without a feeling of strangeness.

### Second Embodiment

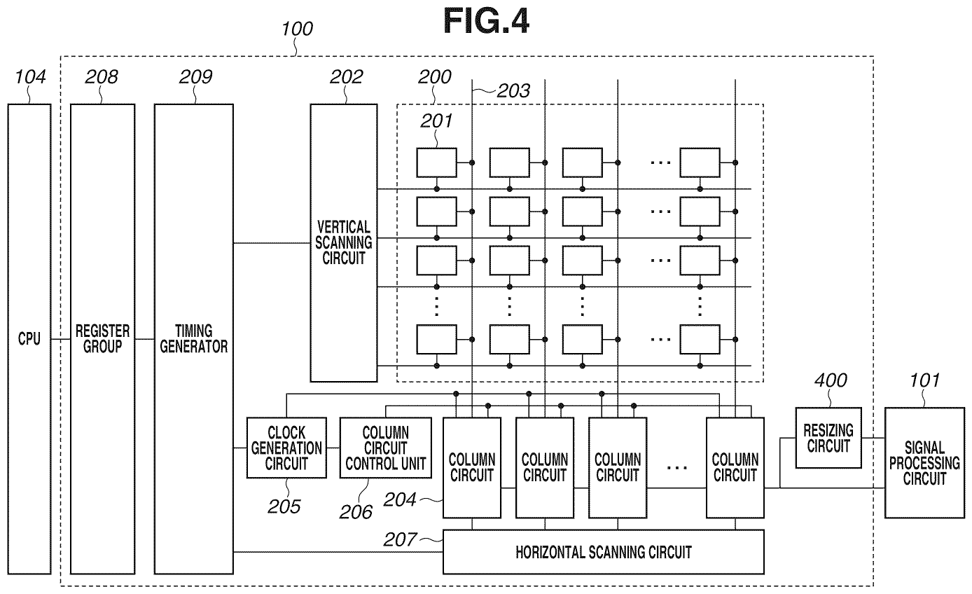

FIG. 4 is a diagram illustrating an overall configuration of an imaging element 100 according to a second embodiment of the present disclosure.

A configuration of the imaging element 100 illustrated in FIG. 4 differs from the configuration of the first embodiment illustrated in FIG. 2, only in that a resizing circuit 400 (resized image generation unit) is added to generate a resized image by thinning and resizing image signals read out from a pixel group 200 in the row direction or column direction. The components other than the resizing circuit 400 are the same as those illustrated in FIG. 2, and thus description thereof will be omitted here.

The resizing circuit 400 receives image signals output from a column circuit 204, resizes the input image signals by thinning out the input image signals in the row direction or column direction to generate a resized image, and transmits the resized image signals to a signal processing circuit 101 provided downstream of the imaging element 100. The resizing circuit 400 may resize image signals by adding together image signals from a plurality of pixel rows or a plurality of pixel columns.

The resizing circuit 400 can change whether to perform a resizing operation and the settings for the resizing operation depending on the set imaging mode and imaging conditions. That is, the resizing circuit 400 can change the number of rows of image signals to be thinned out in the row direction or the number of columns of image signals to be thinned out in the column direction, and the number of rows of image signals to be added in the row direction or the number of columns of image signals to be added in the column direction.

Furthermore, a transmission path is provided for transmitting the image signals output from the column circuit 204 to a signal processing circuit 101 without passing through the resizing circuit 400. This makes it possible to transmit both a resized image signal and an unresized image signal to the signal processing circuit 101 in one image signal readout.

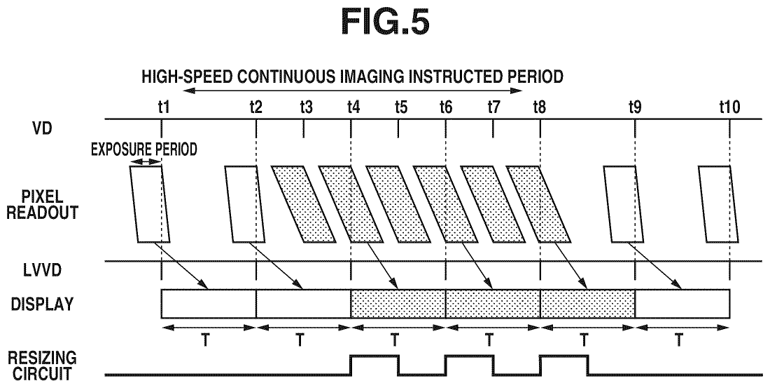

FIG. 5 is a diagram illustrating an operation flow of image signal readout from the imaging element 100 and live view image display in FIG. 3A in the first embodiment described above, to which an operation sequence of the resizing circuit 400 is added. Referring to FIG. 5, an example of the relationship between image signal readout from the imaging element 100 and live view image display in the case of using the resizing circuit 400 will be described.

The resizing circuit 400 is in an operative state when a control signal transmitted from the CPU 104 to the imaging element 100 is high, and the resizing circuit 400 is in an inoperative state when the control signal is low. Hereinafter, the differences from FIG. 3A will be described.

The resizing circuit 400 is used, for example, in a case where when high-speed continuous imaging is instructed and still image signals are used to display live view images, the correction processing or development processing on the still image signals has not been completed within a predetermined time due to insufficient data processing capacity of the signal processing circuit 101.

The resizing circuit 400 reduces the amount of data by thinning out or adding the still image signals in the row or column direction to decrease the resolution to approximately the same degree as that of the live view image signals. The still image signals after being resized (resized image signals) are used to display live view images during high-speed continuous imaging.

Accordingly, even if the data amount of the still image signals output from the pixel group 200 of the imaging element 100 is large, it is possible to display live view images based on the still image signals at a display rate equivalent to that of normal live view image display. The resizing circuit 400 does not necessarily have to be provided inside the imaging element 100, and may be built in the signal processing circuit 101, for example.

Next, operations at individual times will be described.

From time t1 to time t2, the resizing circuit 400 does not operate because live view images are displayed based on normal image signals for displaying live view images.

From time t2 to time t4, a still image capturing operation is performed based on an instruction for high-speed continuous imaging. However, since the still image signal for the first frame is not used to display a live view image, the resizing circuit 400 does not operate here either.

From time t4 to time t5, the resizing circuit 400 is operated to thin out or add the read still image signals for the second frame in the row or column direction. Then, resized images based on the resized still image signals are displayed as live view images on the display unit 107. Furthermore, the still image signals that have not been resized are subjected to correction processing and development processing in the signal processing circuit 101 and then recorded in a memory 105 or a recording unit 106.

Thereafter, the resizing circuit 400 is operated in the case of using still image signals captured while high-speed continuous imaging is continuously instructed to display live view images. After time t9, no still image signal is read out, and the readout of live view image signals and the display of live view images are repeated in the same manner as from time t1 to time t2, so that the resizing circuit 400 is not operated.

As described above, according to the present embodiment, even in the case of displaying live view images based on still image signals with a large amount of data read out during high-speed continuous imaging, it is possible to record the captured original still image data while updating the display of the live view images in the display cycle T. Furthermore, even if the frame rate of still images captured continuously at high speed is higher than the display frame rate of live view images, it is possible to realize a display of seamless and natural live view images without a feeling of strangeness, in the same manner as in the first embodiment.

### Third Embodiment

As a third embodiment, an example will be described in which, if an instruction for high-speed continuous capturing of still images as described in the first and second embodiments is issued, a priority is switched between the continuous capturing speed of still images and reducing a feeling of strangeness in displaying live view images, depending on the preset imaging conditions.

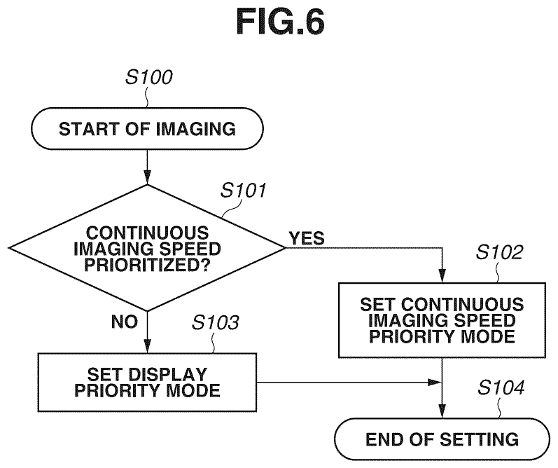

FIG. 6 is a flowchart illustrating operations of an imaging apparatus according to the third embodiment.

In step S100, the imaging apparatus is powered on to start up.

In step S101, it is determined whether the imaging mode previously set in the imaging apparatus is a “continuous imaging speed priority mode” for high-speed continuous imaging. The imaging mode setting does not necessarily have to be determined based on a user instruction, and the imaging apparatus may be configured to automatically determine the imaging mode.

If it is determined in step S101 that the imaging apparatus is set to the “continuous imaging speed priority mode” (YES in step S101), the process proceeds to step S102. If it is determined that the imaging apparatus is not set to the “continuous imaging speed priority mode” (NO in step S101), the process proceeds to step S103.

In step S102, the imaging apparatus is set to operate in the “continuous imaging speed priority mode”. In the “continuous imaging speed priority mode”, if high-speed continuous imaging of still images is instructed, the continuous imaging speed of still images is prioritized and a vertical synchronization signal VD and a display vertical synchronization signal LVVD are not synchronized. For this reason, the continuous imaging speed of still images (the cycle of the vertical synchronization signal VD) does not depend on a display cycle T (predetermined cycle), so that any continuous imaging speed can be set.

In step S103, the imaging apparatus is set to operate in a “display priority mode”. In the “display priority mode”, if high-speed continuous imaging of still images is instructed, the vertical synchronization signal VD and the display vertical synchronization signal LVVD are synchronized as described above in the first and second embodiments. For this reason, the continuous imaging speed of still images (the cycle of the vertical synchronization signal VD) is controlled to depend on the display cycle T (predetermined cycle), thereby reducing a feeling of strangeness in displaying live view images.

Upon completion of the setting of the imaging mode in step S102 or step S103, the process proceeds to step S104. In step S104, the imaging mode setting process is ended.

According to the third embodiment described above, it is possible to switch between the “continuous imaging speed priority mode” and the “display priority mode”. This makes it possible to provide an imaging apparatus that, if high-speed continuous imaging of still images is instructed, strikes a balance between the continuous imaging speed of still images and the display of live view images to meet the needs of the user.

According to the present disclosure, it is possible to provide an imaging apparatus that, in the case of continuously capturing still images for recording, reduces a feeling of strangeness in live view display caused by the timing for reading out image signals from the imaging element and the timing for displaying live view images.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-202203, which was filed on Nov. 20, 2024 and which is hereby incorporated by reference herein in its entirety.

What is claimed is:

1. An imaging apparatus comprising:
an imaging element;
a display unit configured to display a live view image captured by the imaging element;
at least one processor; and
at least one memory that is in communication with the at least one processor, wherein the at least one memory stores instructions for causing the at least one processor and the at least one memory to execute:
performing control to capture a plurality of frames of live view images by the imaging element before execution of continuous capturing of a plurality of frames of still images and to display the captured plurality of frames of live view images on the display unit in a predetermined cycle; and
performing control to continuously capture the plurality of frames of still images by the imaging element without capturing the plurality of frames of live view images during execution of the continuous capturing and to display at least some of the plurality of frames of still images as some of the plurality of frames of live view images on the display unit in the predetermined cycle.

2. The imaging apparatus according to claim 1, wherein the at least one memory further stores instructions for causing the at least one processor and the at least one memory to perform control to display an image obtained by combining the plurality of frames of still images as one of the plurality of frames of live view images on the display unit.

3. The imaging apparatus according to claim 1, wherein the at least one memory further stores instructions for causing the at least one processor and the at least one memory to:
generate a plurality of frames of resized images by resizing the plurality of frames of still images; and
perform control to display a plurality of frames of resized images as some of the plurality of frames of live view images on the display unit.

4. The imaging apparatus according to claim 3, wherein the at least one memory further stores instructions for causing the at least one processor and the at least one memory to perform control to display an image obtained by combining the plurality of frames of resized images as one of the plurality of frames of live view images on the display unit.

5. The imaging apparatus according to claim 1,
wherein the imaging element generates a plurality of frames of resized images by resizing the plurality of frames of still images, and
wherein the at least one memory further stores instructions for causing the at least one processor and the at least one memory perform control to display the plurality of frames of resized images as some of the plurality of frames of live view images on the display unit.

6. The imaging apparatus according to claim 1,
wherein the imaging element generates a plurality of frames of resized images by resizing the plurality of frames of still images, and
wherein the at least one memory further stores instructions for causing the at least one processor and the at least one memory to perform control to display an image obtained by combining the plurality of frames of resized images as one of the plurality of frames of live view images on the display unit.

7. A control method of an imaging apparatus including an imaging element and a display unit configured to display a live view image captured by the imaging element, the method comprising:
capturing a plurality of frames of live view images by the imaging element before execution of continuous capturing of a plurality of frames of still images and performing control to display the captured plurality of frames of live view images on the display unit in a predetermined cycle; and
performing control to continuously capture the plurality of frames of still images by the imaging element without capturing the plurality of frames of live view images during execution of the continuous capturing and to display at least some of the plurality of frames of still images as some of the plurality of frames of live view images on the display unit in the predetermined cycle.
